(19) United States
(12) Patent Application Publication
(10) Pub. No.: US 2002/0050903 A1
(43) Pub. Date: May 2, 2002

(54) SINTERED ARMATURE

(76) Inventors: BARDO KOPPMANN, KALTENBRUNN (DE); NORBERT MITLMEIER, URSENSOLLEN (DE)

Correspondence Address: KENYON & KENYON, ONE BROADWAY, NEW YORK, NY, 10004, US

(21) Appl. No.: 09/355,094

(22) PCT Filed: Jan. 9, 1998
(86) PCT No.: PCT/DE98/00064

(30) Foreign Application Priority Data
Jan. 22, 1997 (DE) 197 02 130.1

(51) Int. Cl. H01H 67/02; H01F 1/00

(52) U.S. Cl. 335/296

(57) ABSTRACT

An armature (1) for a magnetic system of a switchgear, produced in the form of a one-piece sintered part, whose free design makes it possible to easily optimize the flux and mass and reduce production costs. It has an H-shaped profile with lateral, plate-shaped pole faces (2) which are interconnected by a central segment (3) that guides the flux above and beneath a through-hole (4).

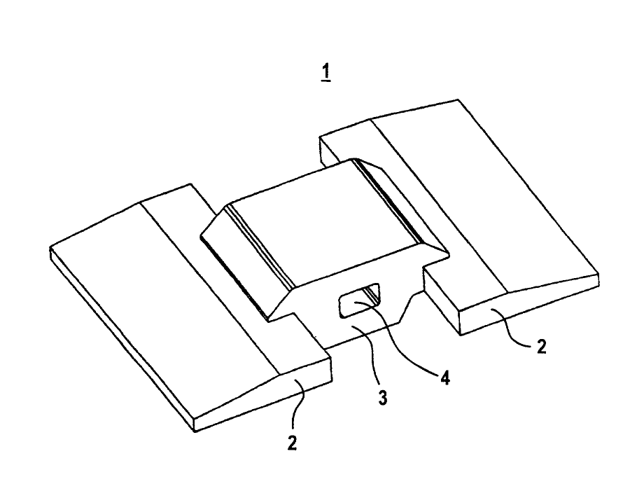

### BACKGROUND INFORMATION

The present invention relates to an armature for a magnetic system, in particular of a switchgear, with a one-piece design and lateral pole faces.

An armature of this type is described in German Patent No. 44 36 832 C1. The armature is designed in the form of a one-piece, magnetically active steel part with an armature plate and a fastening device extending from the latter. It has a bushing for holding a bolt, the bushing being formed by a recess reaching from the bottom of the steel plate into a raised area extending from the latter. The armature is made of a steel block from which the outer contours of the steel plate with the fastening device are milled, as well as, in a further step, a longitudinal opening for creating the bushing. The armature is provided for a magnetic system, in particular a contactor.

The trend toward ever smaller, low-cost solenoid-operated mechanisms, makes it necessary to optimize the geometric dimensions of magnetic systems and reduce the number of parts. To accomplish this, it is advantageous to select the shape of the iron parts so that space can be saved for other elements. The magnetic system armatures designed presently are usually made of steel plates having a uniform thickness. To attach this steel plate to the contact carrier of a contactor, aluminum adapter parts are screwed onto the steel plate in order to reduce mass. If the armature width is to be greatly varied using this technique, the magnetic flux density would enter a state of saturation in partial areas. This produces an elevated magnetic resistance with the known disadvantages in the tensile force variation of the contactor drive.

If we circumvent this iron saturation in partial areas by appropriately adjusting the thickness of the material over the entire part, the result is a larger moving mass, which, in turn, has a negative effect on the drive layout.

If we wished to reduce the armature width in only certain areas without increasing flux density, we could try to improve the arrangement by attaching additional iron parts. However, the armature thickness must be partially increased in this case in order to compensate for the width reduction in the area affected. Retrofitting additional elements, however, creates problems with air gap transitions and the method of connection. Other options, such as milling the part from solid material or producing it by casting, are relatively costly.

The object of the present invention is to provide an armature of the type mentioned in the preamble that can be produced as economically and simply as possible.

According to the present invention, this object is achieved by producing the armature in the form of a sintered part having an H-shaped profile, with the plate-shaped lateral pole faces being interconnected by a central segment which projects over the thickness of both pole faces. A design of this type provides considerable advantages. It allows the armature to have a simple and economical design, providing high-quality surfaces without any later finishing work and simultaneously producing the bushing for holding a bolt. Because the armature may have any desired shape as a sintered part, the flux and mass can be easily optimized.

Due to its H-shaped design and the ability to guide the flux across the thicker central segment, the armature has a space which can be used for other purposes, such as return springs or guides, in the switchgear where the armature will be installed.

The armature is advantageously adjusted to the magnetic flux by having the pole faces tapering toward their edges.

One embodiment of the present invention is explained in greater detail below on the basis of a drawing. The figure shows an armature 1 for a magnetic system, in particular of a switchgear (such as a contactor), designed in a single piece. It has an H-shaped profile with lateral, plate-shaped pole faces 2 which are interconnected by a central segment 3 projecting over the thickness of both pole faces. Armature 1 is produced in the form of a sintered part. Its pole faces 2 are tapered toward their edges to optimize the flux and mass.

In this embodiment according to the present invention, the armature mass is reduced by providing it with a thickness in the pole face region which is adjusted to the cumulative flux. The thickness of the armature in the outer area of the magnetic system is reduced according to the decrease in the magnetic flux. This mass reduction allows the return spring to have a lower restoring force at a given impact resistance of the device where the armature will be installed. The mass reduction consequently has a positive effect on the total force balance in the switchgear, which, in turn, helps decrease the size of the magnetic system and reduce the driving power. The H-shaped profile of the armature, with its lateral recesses, e.g. for return springs or guides, is possible without having to increase the thickness of the armature overall. The magnetic flux can be guided above and beneath through-hole 4 in central segment 3 for holding the bolt.

The ability to freely design the armature in a single piece eliminates the need for additional adapter parts for installing the armature in the contact bridge carrier of a switchgear.

Although the present invention is explained on the basis of the embodiment illustrated in the attached drawing, it should be kept in mind that this is not intended to limit the present invention to the illustrated embodiment, but rather to include all possible variations, modifications, and equivalent arrangements to the extent that they are covered by the content of the patent claims.

1. An armature (1) which is intended for use in a magnetic system, in particular of a switchgear, and which is designed in a single piece and has lateral pole faces (2), characterized in that the armature (1) is produced in the form of a sintered part and has an H-shaped profile, the plate-shaped lateral pole faces (2) being interconnected by a central segment (3) projecting over the thickness of both pole faces.

2. The armature according to claim 1, characterized in that the pole faces (2) are tapered toward their edges.
